(19) United States
(12) Patent Application Publication
(10) Pub. No.: US 2016/0135635 A1
(43) Pub. Date: May 19, 2016

(54) APPARATUS FOR INFUSING A PRODUCT WITH AN HERB

(71) Applicants: Michael Boniello, San Francisco, CA (US); Ralph Boniello, El Cerrito, CA (US)

(72) Inventors: Michael Boniello, San Francisco, CA (US); Ralph Boniello, El Cerrito, CA (US)

(21) Appl. No.: 14/542,562

(22) Filed: Nov. 15, 2014

(51) Int. Cl. A47J 27/00

(52) U.S. Cl. CPC A47J 27/002

(57) ABSTRACT

An apparatus comprises a heating unit for applying heat to a cooking vessel during a slow cooking process. An inner bowl engages the heating unit and receives a mixture to be slow cooked. The mixture comprises an herb and a product into which chemicals from the herb are infused during the slow cooking process. A first lid covers the inner bowl during the slow cooking process. A filtration system comprises a second lid being configured to replace the first lid after the slow cooking process, a plunger extending out from the second top and into the inner bowl, and a plate system being configured to compress the herb to a bottom of the inner bowl.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to cooking appliances. More particularly, the invention relates to a slow cooker with a filtration attachment.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Various different types of foods may be made with herbal extracts (also referred to as ‘herbs’ or ‘herbal’) including, but not limited to, baked goods, candies, drinks, etc. Compounds can be extracted from herbal material by cooking or simmering the plant material in oils, fats, alcohol, or other soluble substances with heat and time. In some instances, herbal extracts may be infused into food items such as, but not limited to butters, oils, shortenings, or liquids that may be used in baking and cooking. For example, without limitation, one may expect that herbal infused butter, oil, shortening, lard, or milk may be substituted for regular butter, oil, shortening, lard, or milk in virtually any recipes.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that it is believed that to fully infuse herbs into butters, oils, and fats, long cooking times at relatively constant temperatures are usually preferred, which may be difficult to achieve when cooking on a stovetop. In some instances slow cookers may be used to infuse herbs into butters, oils, liquids, etc. Many currently available slow cookers may be too large for cooking with consumer amounts of herbs since most slow cookers on the market are sized to cook meats, stews, and other large casseroles. Herbal extractions and infusions typically require a much smaller quantity of herbal materials for the average consumer when compared to normal slow cooker recipes. Due to the relatively small volume of herbs usually being heated in typically large slow cookers, one may expect that there may be increased risk of overheating and burning the herbs and/or infusion substances, which may render the end product displeasing to taste or even useless. Furthermore, these slow cookers typically have no elements for separating the herbs from the butters, fats, oils, etc. once cooking is complete. Traditional methods of filtering herbs from infused butters, fats, and oils typically involve squeezing and straining the cooked herbs from the end product through cheesecloths or similar filtration items, and usually require the direct handling of the cooked herb product and the related waste product. Thus, these methods may be messy and inconvenient.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, 1C and 1D illustrate an exemplary cooking device for herbal infusion, in accordance with an embodiment of the present invention. FIG. 1A is a diagrammatic front view of an outer heating unit. FIG. 1B is a diagrammatic side view of an inner bowl. FIG. 1C is a diagrammatic side view of a lid, and FIG. 1D is a diagrammatic top view of the inner bowl;

FIGS. 2A, 2B and 2C illustrate an exemplary filtration system for a cooking device for herbal infusion, in accordance with an embodiment of the present invention. FIG. 2A is a diagrammatic side view of the filtration system. FIG. 2B is an exploded view of a filtration plate, and FIG. 2C is a side view of a cross plate;

FIG. 3 is a diagrammatic front view of an outer heating unit, in accordance with an embodiment of the present invention;

FIG. 4 is a flowchart illustrating an exemplary method for using a cooking device for herbal infusion, in accordance with an embodiment of the present invention; and

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a system for infusing herbs into butters, oils, fats, etc., which may then be used for cooking purposes of herbal based edibles. For example, without limitation, some embodiments may be used to make basil infused olive oil, rosemary butter, mint vodka, etc. Some embodiments may comprise a countertop slow cooker with an outside heating unit and a ceramic or stoneware inner bowl and a press type filtration attachment for separating the herbs from the butter, oil, fat, water, etc.

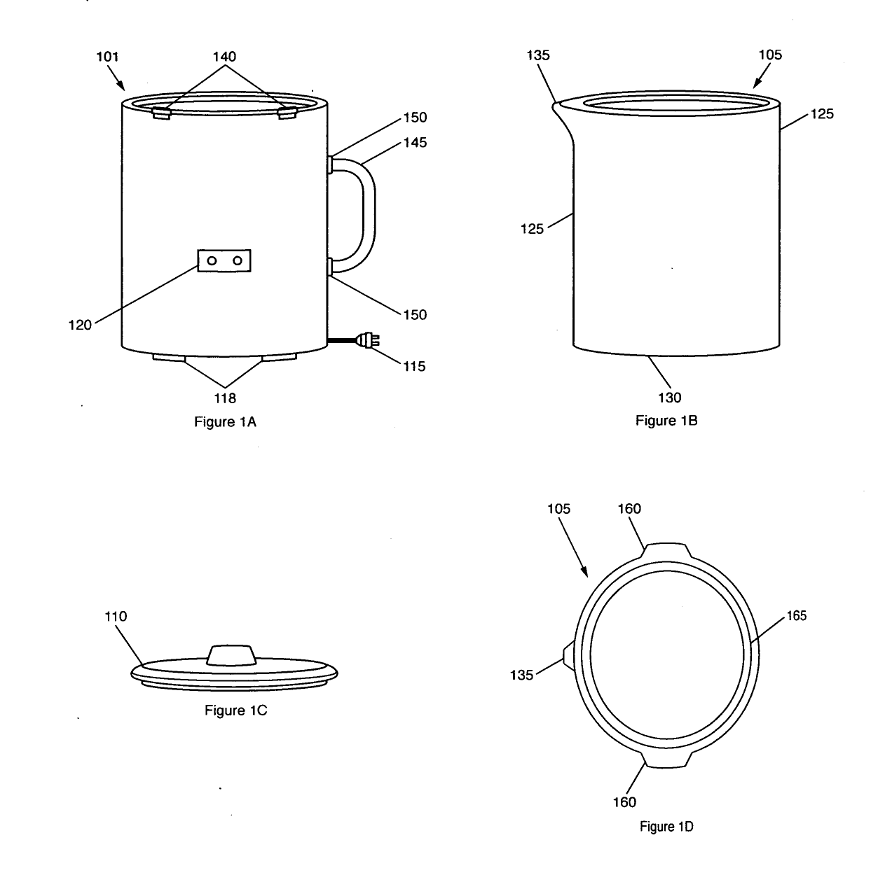

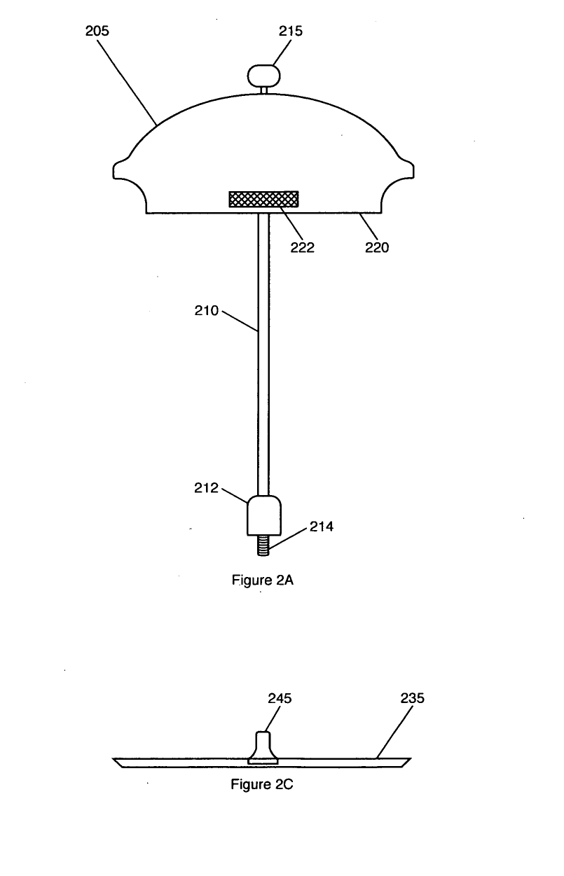

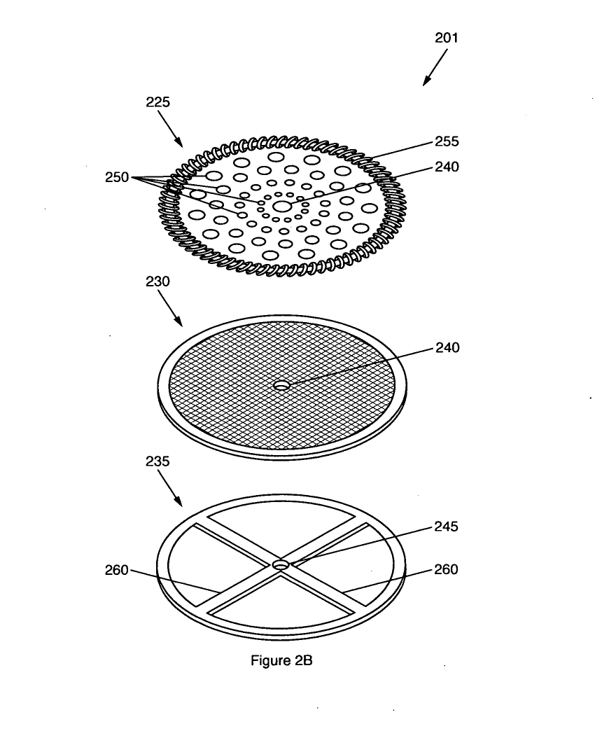

FIGS. 1A, 1B, 1C and 1D illustrate an exemplary cooking device for herbal infusion, in accordance with an embodiment of the present invention. FIG. 1A is a diagrammatic front view of an outer heating unit 101. FIG. 1B is a diagrammatic side view of an inner bowl 105. FIG. 1C is a diagrammatic side view of a lid 110. FIG. 1D is a diagrammatic top view of the inner bowl 105. In the present embodiment, the cooking device may be used with a filtration system that works in a similar manner to a French press as illustrated by way of example in FIGS. 2A, 2B and 2C. Referring to FIG. 1A, in the present embodiment, outer heating unit 101 comprises an electric heating element that can receive power from an electric cord 115 that may be plugged into an electric outlet. In some embodiments, power cord 115 may be detachable at the base of the heating unit. Outer heating unit 101 may also act as a housing for inner bowl 105. It is contemplated that outer heating unit 101 may be made of various different materials including, but not limited to, metal or a combination of metal and plastic, ceramic, rubber, silicone, wood, etc. Some embodiments may comprise a base piece or feet 118 to raise the heating unit off of the surface on which the cooking device is being used. Base piece or feet 118 may be made of a multiplicity of suitable materials such as, but not limited to, rubber, silicone, various plastics, metal, wood, etc. Other embodiments may be implemented without a base piece or feet. Some of these embodiments may comprise added insulation at the bottom of the heating unit to help prevent the surface on which the cooking device is being used from becoming too hot.

In the present embodiment, handle 145 is attached to heating unit 101 by hinge type means 150 to enable handle to swivel. In a non-limiting example, handle 145 may swivel up against heating unit 101 for shipping or storage and swivel to an outward position while heating unit 101 is in use. In an alternate embodiment, hinge type means may include one or more detent positions. In a non-limiting example, a user may rotate handle to the outward position where it snaps into place. In some embodiments, handle 145 may be non-swiveling while in others handle 145 is not present.

In the present embodiment, clamps 140 may hold inner bowl 105 in place when in use. Some embodiment may have two or more clamps space about a top of heating unit 101. In some other embodiments, clamps 140 may include a means for releasing inner bowl for cleaning. Such means may include, without limitation, a button or lever a user may activate. In some alternate embodiments, other means may be used to hold inner bowel in place such as, but not limited to, a frictional means between heating unite 101 and inner bowel 105. In such embodiments clamps 140 would not be present.

In the present embodiment, a control panel 120 may comprise a multiplicity of suitable buttons and displays such as, but not limited to, a power button, a timer, temperature controls, temperature readings, automatic heat reduction via a timer, automatic shutoff via a timer, etc. In some embodiments, settings and options may be digitally displayed via the control panel 120. Furthermore, the control panel may be located in various different places on the heating unit depending on factors such as, but not limited to, the size and shape of the unit, ease of use, aesthetics, etc. In some embodiments, the control unit may be part of the electrical cord. In the present embodiment, when heating unit 101 is powered on and inner bowl 105 is placed inside heating unit 101, the heating element heats up and transfers heat from heating unit 101 to inner bowl 105. In a non-limiting example, heat may be transferred until the contents of the inner bowl reach a simmer point of about 209° F. The temperature of the heating unit 101 may then stabilize at this temperature. In some embodiments, settings on control panel 120 control how quickly the unit reaches the stabilization temperature. As a non-limiting example, both ‘high’ and ‘low’ settings may stabilize at the same temperature and differ in how quickly the unit reaches that point. In some embodiments, depending on how rapidly the contents in the inner bowl 105 are simmering, the user may manually change the heat setting on control panel 120 to achieve a gentle simmer versus a rapid boil.

Referring to FIG. 1B, inner bowl 105 may have a cylindrical shape with vertical sides 125 rising at a 90-degree angle from a bottom surface 130 as opposed to a bowl that tapers towards the bottom, as is typical in current slow cookers. Vertical sides 125 may enable a filtration plate as illustrated by way of example in FIGS. 2A, 2B and 2C to slide up and down inside inner bowl 105 while maintaining a seal around the entire edge of the filtration plate over the entire height of inner bowl 105. One or more pouring spouts 135 may be located at the top rim of inner bowl 105. In addition, the top rim of inner bowl 105 may be flared in multiple areas to form handles. Furthermore, a groove or indentation may be located in the top edge of inner bowl 105 into which lid 110 may be seated during use. FIG. 1D is a diagrammatic top view of the inner bowl 105. In the present embodiment, inner bowel 105 comprises exemplary handles 160 and groove or indentation 165. Alternate embodiments may be implemented with inner bowls of a multiplicity of suitable shapes and outer heating units of corresponding shapes. For example, without limitation, some embodiments may be ovular or rectangular in cross section rather than circular. Moreover, the inner bowls in some embodiments may comprise various different numbers of spouts and handles of various different shapes and sizes. Yet other embodiments may be configured without spouts and/or handles on the inner bowl. In the present embodiment, inner bowl 105 may be made of a dishwasher safe material such as, but not limited to, ceramic or stoneware. Some embodiments may be made of different types of materials that may or may not be dishwasher safe such as, but not limited to, various metals, silicone, some plastics, glass, etc. In the present embodiment, inner bowl 105 may have a 48-ounce capacity with an approximate height range of 7.5-9.0 inches and an approximate inner diameter range of 4.25-4.75 inches. It is contemplated that some embodiments may be implemented in larger and smaller sizes of the inner bowl and outer heating unit. The height, width, and diameter would most likely vary in these embodiments while maintaining similar functional elements including, without limitation, heating elements, control panels, etc. For example, without limitation, one such embodiment may have a 34-ounce capacity with an approximate height of 7.5 inches and an approximate inner diameter of 4.25 inches. A wide range of sizes may be provided by some embodiments such as, but not limited to, cooking devices with a 16-ounce capacity or smaller up to devices with a 50-ounce capacity or even larger.

Those skilled in the art will readily recognize, in light of and in accordance with the teachings of the present invention, that the heating and cooking units in some alternate embodiments may be configured differently. For example, without limitation, in one such embodiment, a cylindrical cooking bowl may be placed on a substantially flat heated base rather than being placed in an encompassing heating unit. In other embodiments the heating unit may be configured to hold multiple cooking units. In yet other embodiments, the shape of the heating unit may be different from the shape of the cooking unit. For example, without limitation, a rectangular heating unit may comprise a cylindrical cavity into which a cylindrical cooking bowl may be placed.

FIGS. 2A, 2B and 2C illustrate an exemplary filtration system for a cooking device for herbal infusion, in accordance with an embodiment of the present invention. FIG. 2A is a diagrammatic side view of a lid and a plunger, FIG. 2B is an exploded view of a filtration member 201, and FIG. 2C is a side view of a cross plate 235. Referring to FIG. 2A, in the present embodiment, the filtration system comprises a plunger lid 205 constructed of heat-tempered glass and has a slight dome shape. In some embodiments the lids may be made of various different materials such as, but not limited to, ceramic, metal, or plastic and may be formed into a variety of shapes including, but not limited to flat lids. The bottom of the plunger lid 205 may have a lip 220 that it is configured to fit snugly into the top of inner bowl 105. In some embodiments, a strainer/pourer may be located on the bottom of lid 205 and within lip 220. As a non-limiting example, strainer/pourer may be aligned with pouring spout 135 to pour out the contents. In the present embodiment, a stainless steel stem 210 fits through a hold in the center of lid 205 and may be able to slide up and down through lid 205. Stem 210 comprises a grip 215 at the top end. A stopper 212 is located on stem 210 just above a threaded end 214. The stopper 212 may hold the spiral plate 225, filter plate 230, and cross plate 235 tightly together when the stem 210 is screwed down into threaded portion 245. Plunger lid 205 may be provided in some embodiments in place of a normal cooking lid. In other embodiments the cooking device may be provided with a typical cooking lid to use during the infusion process and a plunger lid for use in the filtration process.

Referring to FIG. 2B, filtration member 201 comprises a spiral plate 225, a filter plate 230, and a cross plate 235. The plates are placed on top of each other in that order. In the present embodiment, spiral plate 225 is a thin stainless steel plate with holes 250 ranging in diameter from about 3-8 mm in diameter spread across its surface. The circumference of the spiral plate 225 has an upwardly turned lip with small holes, into which a stainless steel spiral wire 255 is woven. The spiral wire 255, around the circumference of spiral plate 225 may provide a flexibility to spiral plate 225 while holding firmly in place as it fits into inner bowl 105. In the present embodiment, filter plate 230 comprises a stainless steel mesh. In other embodiments filter plate 230 may comprises other suitable materials for filtering. The filter plate 230 may be slightly larger than the spiral plate 225, so that it fits up around the edges of spiral plate 225 when the two are in place, with spiral wire 255 pushing the mesh filter against the inner bowl 105 to form a seal along an inner side of vertical sides 125. Spiral plate 225 and filter plate 230 comprise holes 240 through which threaded end 214 may pass. Cross plate 235 comprises a threaded portion 245 that may screw onto threaded end 214 to hold all of the plates against stopper 212. With the plates in place, filtration member 201 may effectively separate butter, oil, liquid, etc. from infusion herbs. Filter plate 230 comprises a porous mesh covering, which may help strain the butter, water, oils, etc. Cross plate 235 forms the bottom of filtration member 201 and comprises cross members 260 to help add rigidity to filtration member 201. In the present embodiment the components of filtration member 201 are typically made of stainless steel. However, it is contemplated that the components of the filtration member in some embodiments may be made of various different materials such as, but not limited to, different metals or various plastics.

FIG. 2C is a side view of a cross plate 235. In the present embodiment, cross plate comprises a threaded portion 245 for mating with threaded end 214.

Referring to FIG. 2A, filtration member 201 is pulled up by grip 215 on stem 210 to meet plunger lid 205, and then lid 205 is placed on the inner cooking bowl. Filtration member 201 may then be pushed towards the bottom of the inner cooking bowl with grip 215. As the filtration member 201 is pressed downwards through the contents of the inner bowl, any solids are caught by filtration member 201 and pushed toward the bottom of the inner bowl while any liquids or oils are able to pass through the various holes in the plates of filtration member 201. Depending on the type of infusion being made, strong pressure may be placed on filtration member 201 to squeezes as much of the liquid from the solids as possible. Once the solids are compressed to the bottom of the inner bow, the remaining liquid can be poured off. It is believed that this filtration method may be less messy than traditional methods. This method may also be more effective than some traditional methods using cheesecloth since the mesh size of cheesecloth may be too large for smaller or finely-ground herbal materials or other infusion ingredients. Furthermore, this filtration method typically minimizes the amount of direct handling of the materials required to separate the solids from the liquids or oils.

Those skilled in the art will readily recognize, in light of and in accordance with the teachings of the present invention, which a multiplicity of suitable variations to the filtration method and system may be made in some embodiments. For example, in some embodiments the number and density of the various plated in the filtration member may vary, which may enable the filtration system to accommodate infusion ingredients that are finer ground or more course. In some embodiments, the filtration plates may be thinner or thicker. In another embodiment, a hole or spout may be located near the bottom portion of the inner bowl and/or outer heating unit that may be controlled by a valve, similar to that of a hot coffee dispenser. A filtering screen may be built into the spout or may be located right at the entrance of the spout. In this embodiment a flat plate without holes may be used to press down on the contents of the bowl to squeeze the liquid out through the bottom hole or spout. In yet another alternate embodiment, a filtration basket may be placed in the bottom of the inner cooking bowl. Infusion ingredients may then be placed into the filtration basket. Once cooking is complete, the filtration basket may be pulled up through the contents to catch the solids while the liquids or oils pass through holes or mesh in the basket and remain in the inner bowl. The solids may then be discarded, and the infused liquid or oil may be ladled or poured out of the inner bowl for use.

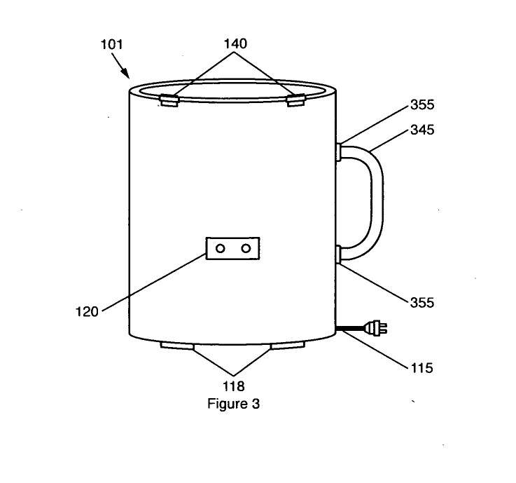

FIG. 3 is a diagrammatic front view of an outer heating unit, in accordance with an embodiment of the present invention. In the present embodiment, removable handle 345 engages outer heating unit 101 via means 355. In the present embodiment, means 355 may include, without limitation, slots that may engage ends of handle 345 for installation or removal of handle 345. In other alternative embodiments, means 355 may include, but not limited to, mechanical clamps, magnetic clamps, clips, pins, etc.

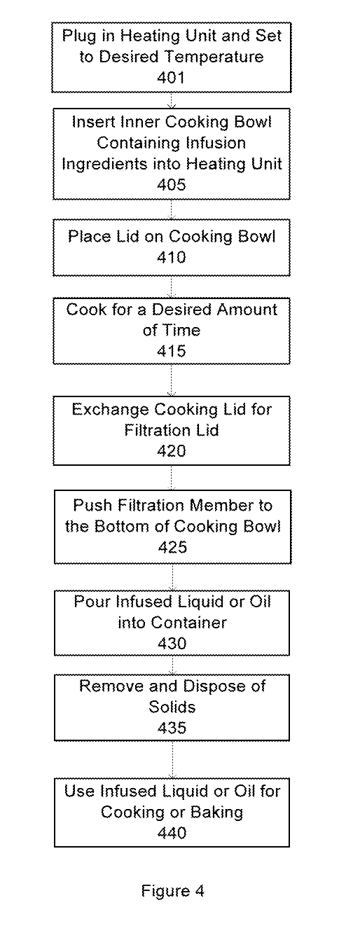

FIG. 4 is a flowchart illustrating an exemplary method for using a cooking device for herbal infusion, in accordance with an embodiment of the present invention. In typical use of the present embodiment, the cooking device may be used to make easily filterable small batches of herbal oils and butter by virtually anyone, even a novice or someone who knows nothing about herbs and/or cooking. The process begins in step 401 with plugging the heating unit into a standard electrical outlet and setting the controls to the desired temperature, for example, without limitation, between 190 and 220 degrees Fahrenheit. In step 405 the inner cooking bowl full of ingredients may be inserted into the heating unit. Alternatively, the ingredients may be placed into the cooking bowl after the bowl is inserted into the heating unit. In step 410, the cooking lid is placed on the cooking bowl. The ingredients are then cook at the preset temperature for a desired amount of time in step 415. During the cooking step, the ingredients may be stirred occasionally. Stirring the ingredients is optional and may depend on factors such as the type of ingredients in the cooking bowl, the cooking temperature, the cooking time, etc. In step 420, the cooking lid is removed, and the plunger lid with the filtration member is placed on the cooking bowl. Then, the filtration member is slowly pushed to the bottom of the cooking bowl in step 425. Additional pressure may be applied once the filtration member is at the bottom to squeeze out the majority of the liquid or oil remaining in the solid contents. In step 430 the infused liquid or oil may be poured into the desired container or containers. The remaining solids in the cooking bowl may then be removed from the cooking bowl and disposed of for example, without limitation, as compost or as garbage in step 435. Finally, in step 440, the infused oil, butter, liquid, etc., may be used for cooking or baking in virtually any recipe. Cleaning the cooking device after use is typically simple since all elements except the electrical heating unit are dishwasher safe. The present embodiment may be used not only as a specialized cooker for infusing herbs into oil, butter, liquids, etc. The cooking device may also be used to cook other types of herbal extracts or flavored butters, oils, and liquids such as, but not limited to, basil or rosemary infused butter, ginger tea, garlic and herb oil, etc. In some embodiment, the cooking bowl and/or lids may be made from materials that are not dishwasher safe. In another use of the present embodiment, the cooking device may be used to cook almost any food item in a similar manner to a typical slow cooker.

Those skilled in the art will readily recognize, in light of and in accordance with the teachings of the present invention, that some embodiments may be implemented with various additional and alternate features such as, but not limited to alarms, vents in the lid to enable steam to escape, clamps to hold the lid on, attachable utensils, etc. In one alternate embodiment the filtration system may be operated by a crank built into the lid rather than by pushing the filtration member straight down. Another alternate embodiment may comprise a filtering screen at the pouring spout of the cooking bowl to catch any solids that may have passed through the primary filtration system.

Some embodiments of the present invention may provide advantages over currently available means for herbal infusion. For example, without limitation, some embodiments may be smaller in size to help prevent overcooking or burning of the contents since small batches are often made when cooking herbal infusions. Also, providing a filtration system typically enables a user to easily separate the remaining plant solids from the fats, oils, or liquids in a convenient and tidy manner. Some embodiments may incorporate means for easily pouring the finished infusion into containers. Furthermore, the use of dishwasher safe materials in some embodiments may aid in easy cleanup. By using a cooking device according to an embodiment of the present invention, a consumer may be able to make herbal edibles at home thus avoiding the high cost of purchasing herbal based edibles at higher end grocery stores while not being limited by the types edibles sold through stores. The consumer may use the resulting infusion to make virtually any herbal based food item that comprises butter, oils, fats, or some liquids in the ingredients, including, but not limited to, baked goods, meat or vegetables cooked in butter or oil, salad dressings, etc. The infused butter or oil may also be used on its own, for example, without limitation, as a dip or spread for bread or drizzled over popcorn. Therefore, the consumer may explore their own food creations using the herbal infused butters and oils, and also has ultimate control over the type and amount of herbs used, and the concentration of extract in the resulting infusion.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a slow cooker with a filtration attachment according to the present invention will be apparent to those skilled in the art. Various aspects of the invention have been described above by way of illustration, and the specific embodiments disclosed are not intended to limit the invention to the particular forms disclosed. The particular implementation of the slow cooker and filtration attachment may vary depending upon the particular context or application. By way of example, and not limitation, the slow cookers and filtration attachments described in the foregoing were principally directed to implementations for making herbal infusions with butter, oil, or other fats; however, similar techniques may instead be applied to making different types of infusions such as, but not limited to, fruit infused tea, vanilla infused coffee, vinegars infused with various flavors, or aromatherapy oils, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What we claim is:

1. An infusing apparatus comprising:
a heating unit to apply heat to a cooking vessel to facilitate a cooking process;
an inner bowl to engage said heating unit and receive a solids and a liquid mixture for the cooking process, wherein the mixture produces a product by which chemicals from the solids infuse into the liquid during the cooking process;
a first lid to cover said inner bowl during the cooking process; and
a filtration system to engage said inner bowl to substantially separate the solids from the infused product, said filtration system comprising: a second lid to replace said first lid after the cooking process, wherein said second lid comprises; a plunger longitudinally actuatable through in a center portion of said second lid and into said inner bowl; and a plate system coupled to said plunger to facilitate compressing the solids to a bottom portion of said inner bowl.

2. The apparatus as recited in claim 1, further comprising clamps to retain said inner bowl within said heating unit during the cooking process.

3. The apparatus as recited in claim 1, further comprising a control panel to control the applied heat by said heating unit during the cooking process

4. The apparatus as recited in claim 1, further comprising support elements to support said heating unit on a surface.

5. The apparatus as recited in claim 1, further comprising a handle coupled to said heating unit to manipulate said heating unit by a user.

6. The apparatus as recited in claim 5, further comprising hinges to couple said handle to said heating unit.

7. The apparatus as recited in claim 6, wherein said hinges provide for said handle to swivel.

8. The apparatus as recited in claim 6, wherein said handle to removably couples to said heating unit.

9. The apparatus as recited in claim 1, wherein said second lid further comprises a lip portion for reception by a recessed, top perimeter portion of said inner bowl, said lip portion further comprising a an integrated strainer/pourer.

10. The apparatus as recited in claim 1, wherein said inner bowl further comprises handles.

11. The apparatus as recited in claim 1, wherein said plate system further comprises a spiral plate comprising a spiral wire woven about a circumferential edge portion of said spiral plate.

12.-17. (canceled)

18. An infusing apparatus comprising:
a heating unit to apply heat to a cooking vessel to facilitate a cooking process;
an inner bowl to engage said heating unit and receive a solids and a liquid mixture for the cooking process, wherein the mixture produces a product by which extracted compounds from the solids infuse into the liquid during the cooking process;
a first lid to cover said inner bowl during the cooking process; and
a filtration system to engage said inner bowl to substantially separate the the solids from the infused product, said filtration system comprising:
a second lid to replace said first lid after the cooking process, wherein said second lid comprises;
a plunger longitudinally actuatable through in a center portion of said second lid and into said inner bowl;
and a plate system coupled to said plunger to facilitate compressing the solids to a bottom portion of said inner bowl, wherein said plate system further comprises a spiral plate comprising a spiral wire woven about a circumferential edge portion of said spiral plate.

19. The apparatus as recited in claim 18, further comprising:
clamps to retain said inner bowl within said heating unit during the cooking process;
a control panel to control the applied heat by said heating unit during the cooking process; support elements to support said heating unit on a surface;
a handle coupled to said heating unit to manipulate said heating unit by a user; hinges to affix said handle to said heating unit; the said second lid further comprises a lip portion for reception by a recessed, top perimeter portion of said inner bowl, said lip portion comprising an integrated strainer/pourer, and in which said inner bowl further comprises handles.

20. The apparatus as recited in claim 19, wherein the solids comprise at least one herb.

21. The apparatus as recited in claim 20, wherein the liquid comprises at least one of; a melted butter, a lard, an oil, a fat derivative, an alcohol, and a water.

22. A cooking apparatus comprising:
a heating unit to provide heat to a mixture to be cooked;
a filtering mechanism to filter within the heating unit at least one solid from a liquid of the mixture; and
a decanting mechanism to withdraw the filtered liquid from the heating unit.

23. The apparatus of claim 22, wherein the decanting mechanism comprises a valve at a bottom portion of the heating unit to tap the liquid from the heating unit.

24. The apparatus of claim 23, wherein the filtering mechanism comprises of at least one mesh screen to filter the at least one solid from the liquid.

25. The apparatus of claim 24, wherein the mesh screen comprises a surface area an amount slightly larger than a cross-sectional area of the heating unit.

26. The apparatus of claim 25, wherein the at least one solid comprises of at least one herb and the liquid comprises at least one of; a melted butter, an oil, a lard, a derivative fat, an alcohol and a water.
